(19) United States
(12) Patent Application Publication
(10) Pub. No.: US 2008/0279142 A1
(43) Pub. Date: Nov. 13, 2008

(54) Method for Adaptive Transmit Power Allocation in Multiuser Ofdm System

(76) Inventors: Byoung-Gi Kim, Daejon (KR); Kun-Seok Kang, Daejon (KR); Do-Seob Ahn, Daejon (KR); Ho-Jin Lee, Daejon (KR)

Correspondence Address: LADAS & PARRY LLP, 224 SOUTH MICHIGAN AVENUE, SUITE 1600, CHICAGO, IL, 60604, US

(21) Appl. No.: 12/096,205

(22) PCT Filed: Nov. 9, 2006
(86) PCT No.: PCT/KR06/04674

§ 371 Date: Jun. 5, 2008

(30) Foreign Application Priority Data
Dec. 9, 2005 (KR) 10-2005-0121134
Apr. 3, 2006 (KR) 10-2006-0030283

(51) Int. Cl. H04Q 7/20

(52) U.S. Cl. 370/329

(57) ABSTRACT

Provided is a method for adaptive transmit power allocation in a multiuser OFDM system. The method includes: a) obtaining a channel gain for a predetermined bit period for each user at a predetermined time, and allocating all of available sub carriers to a user farthest separated among a plurality of users having a good channel gain; b) comparing a channel gain of the user allocated with the subcarrier at the step a) with an initial threshold value; c) allocating a transmit power uniformly to each of the sub carries allocated at the step a) using an Equal-power allocation algorithm if the channel gain is larger than the initial threshold value at the step b); and d) allocating a transmit power to each of the sub carriers allocated at the step a) using a water-filling power allocation algorithm if the channel gain is smaller than the initial threshold value at the step b).

### TECHNICAL FIELD

The present invention relates to a method for adaptive transmit power allocation in a multiuser orthogonal frequency division multiplexing (OFDM) system; and more particularly, to a method for adaptive transmit power allocation in a multiuser OFDM system for effectively managing resources such as sub carriers and transmit power in a multiuser OFDM based satellite/mobile communication system, and reducing a data rate around a cell boundary and a computing burden at the same time.

### BACKGROUND ART

An orthogonal frequency division multiplexing (OFDM) scheme has been used as an effective method for transmitting data at high speed through a wired or wireless channel. The OFDM scheme uses multi-carriers to transmit data. That is, the OFDM scheme is multi carrier modulation (MCM) that transmits the data by parallelizing an input symbol sequence and modulating each of the parallelized symbol sequences to a plurality of sub carriers having mutual orthogonality.

If sub carriers are sampled, the sampling result shows that interference does not occur although spectrums overlap with each other. Since each sub-channel transmits data at a low bit rate, interference between symbols does not occur or seldom occurs.

Since the OFDM scheme is suitable for high speed data transmission, it was selected as the standard for a high speed wireless local area network (LAN) of IEEE 802.11a and HIPERLAN/2, which are selected in United States of America and Europe for providing service in an indoor wireless environment. The OFDM scheme is also selected as a broadband wireless access (BWA) standard of IEEE 802.16.

Furthermore, the OFDM scheme is used for wireless broadband Internet (WiBro) which has been receiving attention in South Korea. The OFDM scheme sustains similar specifications of IEEE 802.16 Wireless MAN for flexibility.

Particularly, since a broadband is generally used in the next generation communication system for transmitting data at high speed, the frequency selectivity characteristics of a channel becomes increased. In this case, it is very ineffective if a same modulation scheme and a same power allocation scheme are applied to all sub carriers. In other words, the capacity of a given channel can be maximized by adaptively applying the optimal modulation and power allocation schemes depending on a signal to noise ratio (SNR) of the given sub carrier.

In order to optimally allocate resources to each sub carrier, a large amount of information is required at a transmitter and a receiver. Therefore, many signals are transmitted through a feedback channel, thereby causing overhead and computation increment.

In order to overcome the traffic overhead and the computation complexity problem, a conventional technology was introduced in U.S. Publication No. 20050078757 entitled “SUBCARRIER AND BIT ALLOCATION FOR REAL TIME SERVICES IN MULTIUSER ORTHOGONAL FREQUENCY DIVISION MULTIPLEXING (OFDM) SYSTEMS.”

The conventional technology teaches a method for repeatedly allocating bits and power by calculating the channel gain of each terminal through a water-filling algorithm in real time in a view of limited power transmission which directly related to quality of service (QoS) of a real time service.

The conventional technology may be advantageous in a view of deciding the transmit power by computing the channel gain in real time through the water-filling algorithm. However, the conventional technology has a problem that the computation amount and complexity have increased exponentially. In order to overcome the problem of the mess computation amount and high complexity, another technology was introduced in an article entitled “TRANSMIT POWER ADAPTATION FOR MULTIUSER OFDM SYSTEMS,” IEEE JOURNAL ON SELECTED AREAS IN-COMMUNICATIONS, VOL. 21. NO. 2, FEB. 2003.

The article teaches a method of deciding a transmit power adaptively in an OFDM system, including two steps for overcoming the problems of the mess computation amount and the high complexity.

The first step is a sub carrier allocation step. In the sub carrier allocation step, all sub carriers are allocation to a user having the best channel gain among users. The second step is a transmit power deciding step. In the transmit power deciding step, the total transmit power is divided by the number of sub carriers in order to reduce the computation complexity in the OFDM system and the divided same transmit power is identically allocated to each sub carrier.

Although the system complexity can be significantly reduced, the performance thereof may be degraded in a view of bandwidth efficiency, that is, a total throughput.

### DISCLOSURE OF INVENTION

### Technical Problem

It is, therefore, an object of the present invention to provide a method for adaptive transmit power allocation in a multiuser orthogonal frequency division multiplexing (OFDM) system; and more particularly, to a method for adaptive transmit power allocation in a multiuser OFDM system for effectively managing resources such as sub carriers and transmit power in a multiuser OFDM based satellite/mobile communication system, and reducing the data rate around a cell boundary and a computing burden at the same time.

It is another object of the present invention to provide a method for adaptive transmit power allocation in a multiuser OFDM system for reducing a system complexity and increasing the overall data efficiency by allocating limited resources such as sub carriers, bits and powers using a water-filling power allocation algorithm and equal power allocation algorithm adaptively at a plurality of user terminals for transmitting data using horizontal sub carriers in OFDM scheme.

### Technical Solution

In accordance with one aspect of the present invention, there is provided a method for adaptively allocating transmission power in a multiuser orthogonal frequency division multiplexing (OFDM) system, the method including the steps of: a) obtaining a channel gain for a predetermined bit period for each user at a predetermined time, and allocating all of available sub carriers to a user farthest separated among a plurality of users having a good channel gain; b) comparing a channel gain of the user allocated with the subcarrier at the step a) with an initial threshold value; c) allocating a transmission power uniformly to each of the sub carries allocated at the step a) using an Equal-power allocation algorithm if the channel gain is larger than the initial threshold value at the step b); and d) allocating a transmission power to each of the sub carriers allocated at the step a) using a water-filling power allocation algorithm if the channel gain is smaller than the initial threshold value at the step b).

### ADVANTAGEOUS EFFECTS

A method for adaptive transmit power allocation according to the present invention can effectively manage limited resources such as sub carriers and transmit power in a multiuser OFDM based satellite/mobile communication system in a view of wireless resource management, and increases the data rate around a cell boundary and reduces the computation burden at the same time.

In the method for adaptive transmit power allocation according to the present invention, the transmit power for sub carriers that will experience deep fading is decided using a water-filling power allocation algorithm, and the decided transmit power is allocated to the sub carriers that will have deep fading. On the contrary, a lower transmit power is allocated to sub carriers having good channel gain using a simple Equal-power allocation algorithm for minimizing the transmit power while sustaining the high data rate.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram illustrating a transmitter in a mobile satellite communication system using an orthogonal frequency division multiplex (OFDM) scheme in accordance with the related art;

FIG. 2 is a block diagram illustrating a receiver of a mobile satellite communication system using an OFDM scheme in accordance with the related art;

FIG. 3 is a block diagram illustrating a mobile communication system in an OFDM in accordance with an embodiment of the present invention; and

FIG. 4 is a flowchart illustrating a method of adaptive transmit power allocation in a multiuser OFDM system in accordance with an embodiment of the present invention.

### BEST MODE FOR CARRYING OUT THE INVENTION

Other objects and aspects of the invention will become apparent from the following description of the embodiments with reference to the accompanying drawings, which is set forth hereinafter.

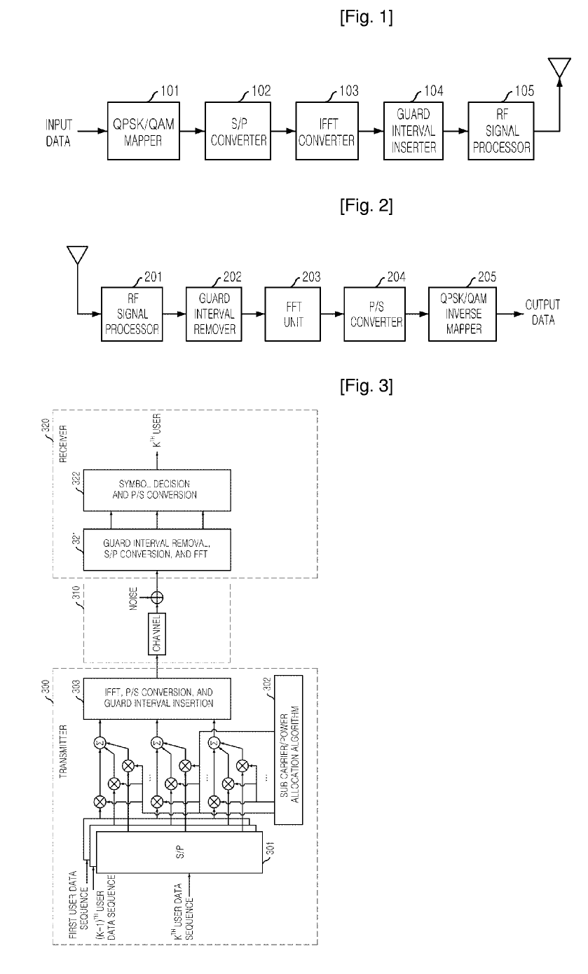

FIG. 1 is a block diagram illustrating a transmitter in a mobile satellite communication system using an orthogonal frequency division multiplex (OFDM) scheme in accordance with the related art.

Referring to FIG. 1, the transmitter includes a QPSK/QAM mapper 101, an S/P modulator, an IFFT unit 103, a guard interval inserter 104, and a RF signal processor 104.

The QPSK/QAM mapper 101 is a modulator in the transmitter, where QPSK stands for quadrature phase shift keying and QAM stands for quadrature amplitude modulation. The QPSK/QAM mapper 101 modulates input data based on a pre-determined modulation scheme and outputs the modulated symbols. The input data denotes data encoded at a predetermined code rate and interleaved. The modulation scheme may be one of 8 phase shift keying (8PSK), 16 quadrature amplitude modulation (16QAM), 64QAM and quadrature phase shift keying (QPSK).

The serial/parallel (S/P) converter 102 converts the consecutive modulated signals outputted from the QPSK/QAM mapper 101 to parallel signals, and the inverse fast Fourier transform (IFFT) unit 103 performs the IFFT on the parallel signals outputted from the S/P converter 102.

The guard interval inserter 104 inserts a guard interval for each OFDM symbol outputted from the IFFT unit 103. Generally, the OFDM symbol is influenced by a previous symbol while traveling through the multi-path channel. The guard interval is inserted between the consecutive blocks for preventing the interference from being arisen between the OFDM symbols.

The radio frequency (RF) processor 105 performs a RF signal process on the OFDM symbols outputted from the protection region inserter 104, and transmit the processed symbols to multi-patch channel through the antenna.

FIG. 2 is a block diagram illustrating a receiver of a mobile satellite communication system using an OFDM scheme in accordance with the related art.

Referring to FIG. 2, the receiver includes a RF signal processor 201, a guard interval remover 202, a FFT unit 203, a P/S converter 204, and a QPSK/QAM inverse mapper 205. The RF signal processor 201 converts the input signal into an intermediate frequency band through down-conversion, and the guard interval inserter 202 removes the guard interval from the OFDM symbol.

The fast Fourier transform (FFT) unit 203 perform a FFT on the OFDM symbols outputted from the guard interval remover 202, and the P/S converter 204 converts the parallel signals outputted from the FFT unit 203 to consecutive symbols.

Then, the QPSK/QAM inverse mapper 205 demodulates modulated symbols using a demodulation scheme corresponding to the modulation scheme used in the transmitter shown in FIG. 1. Then, the QPSK/QAM inverse mapper 205 outputs coded bits.

FIG. 3 is a block diagram illustrating a mobile communication system in an OFDM in accordance with an embodiment of the present invention. That is, FIG. 3 shows a transmitter 300 for allocating sub carriers and transmit power in a multiuser OFDM scheme, and a corresponding receiver 320. The transmitter 300 includes an S/P conversion block 301, a sub carrier/power allocation algorithm 302, and an IFFF, P/S conversion and guard interval insertion block 303, and the receiver 320 includes a guard interval removal, S/P inversion and FFT block 321 and a symbol decision and P/S conversion block 322.

The present invention relates to a method for adaptive transmit power allocation in a multiuser OFDM system for reducing a system complexity and increasing the overall data efficiency.

Referring to FIG. 3, a predetermined user is decided using a sub carrier allocation algorithm 302, and a weight is multiplied to a corresponding sub carrier data signal using a power allocation algorithm 302 in order to maximize a data rate for transmitting the bits of each sub carrier.

The S/P conversion block 301 transforms user's data sequences from a consecutive data signal to parallel data signals for performing an IFFT at the IFFT block 303.

Then, the parallel data sequences from the S/P conversion block 301 are combined with the result of the sub carrier and power allocation 302. After ward, the combined signal is transmitted after passing through the IFFT, the P/S conversion and the guard interval insertion at the IFFT, P/S conversion and quid interval insertion block 303. In the guard interval insertion, a guard interval is inserted among consecutive blocks to prevent the interference of OFDM symbols.

The receiver 320 receives the transmitting signal through the multipath channel 310. The receiver 320 removes a guard interval from the received signal, converts the received signal to a data sequence through a serial/parallel conversion, and outputs coded symbols through the FFT.

The receiver decides a symbol from the fast Fourier transformed signal, transforms the parallel symbol to the consecutive symbol, and outputs the output bits of the k^{th} user.

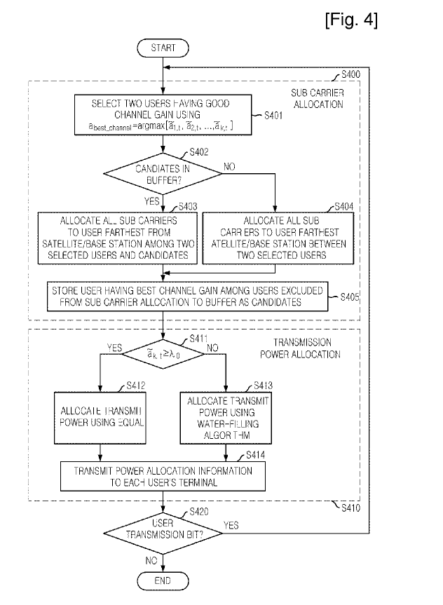

FIG. 4 is a flowchart illustrating a method of adaptive transmit power allocation in a multiuser OFDM system in accordance with an embodiment of the present invention.

The adaptive transmit power allocation method according to the present embodiment is generally divided into two procedures, a first procedure 400 for allocating all sub carriers to a predetermined user at a predetermined time, and a second procedure 410 for allocating transmit power to each of the sub carriers allocated to the predetermined user.

At first, the first procedure 400 for allocating all sub carriers to a predetermined user will be described.

In order to allocate all sub carriers to a predetermined time at a predetermined time, two users having a good channel gain are selected using Eq. 1 at step S401.

That is, a channel gain of each user is obtained for a predetermined bit period at a predetermined time, and decides two users having the good channel gain.

$${a}_{best\_channel} = arg max [ {\tilde{a}}_{1 , t} , {\tilde{a}}_{2 , t} , … , {\tilde{a}}_{k , t} ] \qquad Eq . 1$$

In Eq. 1,k denotes the k^{th} user, and t denotes the predetermined time.

Then, it determines whether candidates are present in a buffer or not at step S402. If the candidates are present in the buffer at step S402, that is, if candidates are currently excluded, it selects a user farthest from a satellite and a base station among the two selected users and the candidates stored in the buffer. Then, it allocates all available sub carriers to the selected user at step S403. If the candidates are not present in the buffer as like when the algorithm of FIG. 4 initially starts, it selects a user farthest from a satellite and a base station among the two selected users selected at step S401 and allocates all available sub carriers to the selected user at step S404.

After allocating all of the available sub carriers, the buffer is emptied. Then, it selects one with the best channel gain from users who did not receive the sub carriers at the steps S403 and S404, and stores the selected user into the buffer as a candidate at step S405. For the reference, the candidates stored in the buffer at the step S402 are also stored in the buffer by the operation described in the step S404.

Hereinafter, the second procedure 410 for allocating transmit power to each of sub carriers will be described.

In the present embodiment, one of an Equal-power allocation algorithm and a water-filling power allocation algorithm is selected according to whether Eq. 2 is satisfied or not, and the selected one is applied as the algorithm for deciding transmit power to allocate to each of the sub carriers.

\tilde{α}_{k,t}≧λ₀ Eq. 2

In Eq. 2, λ₀ is an initial threshold value decided using a water-filling power allocation algorithm initially.

If a channel gain

\tilde{α}_{k,t}
of a user who received the sub carriers at the step S400 is greater than a predetermined threshold value at step S411, the transmit power is allocated to each of the sub carriers using the Equal-power allocation as like Eq. 3 at step S412. That is, if the channel gain
\tilde{α}_{k,t}
of a predetermined user is greater than the predetermined threshold value at a pre-determined time at step S411, the simple Equal-power allocation algorithm is used to allocate the transmit power to each sub carrier at step S412. If the channel gain
\tilde{α}_{k,t}
of a predetermined user is smaller than the predetermined threshold value at a pre-determined time at step S411, a more precious water-filling power allocation algorithm as like Eq. 4 is used to allocate the transmit power to each of the sub carriers at step S413.

$$\begin{matrix}{s}_{{k}_{m}^{*}} = \frac{\overline{S} ( 1 - \frac{{M}_{water \text{-} filling}}{{M}_{water \text{-} filling} + {M}_{equal}} )}{{M}_{equal}} , & for m = 1 , 2 , … , M \\ {s}_{k , , m} = 0 , & for k \neq {k}_{m}^{*}\end{matrix} \qquad Eq . 3$$

In Eq. 3,

### S_{k*}_{ₘ}

denotes transmit power to allocate to the m^{th} sub carrier of the (k*ₘ)^{th} predetermined user who is allocated with the sub carriers at the step S400.

### S_{k,m}

denotes transmit power allocated to the m^{th} sub carrier of the k^{th} user. Since k≠k*ₘ,
if S_{k,m}=0, the transmit power of 0 is allocated to the m^{th} sub carrier of all users except the (k*ₘ)^{th} predetermined user who was allocated with the sub carrier at the step S400. M_{water-filling} denotes the number of sub carriers for using the water-filling algorithm, and M_{eqal} denotes the number of sub carriers for using the equal power allocation algorithm. M denotes the total number of sub carriers to allocate to a predetermined user.

### S̅

is a total transmit power. Furthermore,

k*ₘ=arg max[|α_{1,m}|²,|α_{2,m}|², . . . , |α_{K,m}|²

is a part detecting a user having the largest channel gain of the m^{th} sub carrier.

$$( \begin{matrix}{s}_{{k}_{m}^{*}} = \frac{{N}_{0} {B}_{water \text{-} filling} Γ}{{M}_{water \text{-} filling}} ( \frac{1}{{λ}_{0}} - \frac{1}{{\vert {α}_{{k}_{m}^{*}} \vert}^{2}} ) , & for m = 1 , 2 , … , M \\ {s}_{k , m} = 0 , & for k \neq {k}_{m}^{*}\end{matrix} \qquad Eq . 4$$

In Eq. 4,

### S_{k*}_{ₘ}

denotes a power to allocate to the m^{th} sub carrier of the (k*ₘ)^{th} predetermined user who is allocated with the sub carriers at the step S400. N₀ is a noise power density. M_{water-filling} denotes the number of sub carriers for using the water-filling algorithm, and M_{eqal} denotes the number of sub carriers for using the equal power allocation algorithm. Γ is a target bit error rate (BER). λ₀ is a threshold value to select one of the water-filling power allocation algorithm and the equal power allocation algorithm, and it also denotes an initial threshold value decided using the water-filling power allocation algorithm at the initial time.
α_{k*}_{ₘ}
is the channel gain of the m^{th} sub carrier of a predetermined user who is allocated with all sub carriers at the step S400.

The reason of using two different algorithms for two distinct channel conditions as described above is to more accurately decide a transmit power for a sub carrier that will experience a deep fading in order to maximize the total data rate. A proper level of data rate can be provided although the transmit power of sub carriers that will not experience comparatively deep fading is decided by a simple algorithm. Therefore, using two algorithms adaptively can lower the system complexity and improve the overall data rate. Also, the voice quality around a cell boundary can be improved by firstly allocating all of the sub carriers to a user farthest from a base station at step S403.

Afterward, the information about the transmit power allocated to the sub carriers and about the sub carriers allocated to a user at the steps S410 and S400 is transmitted to the receiving terminal of each user as channel state information (CSI) at step S414.

Then, if the transmit bits of a current user who was allocated with the transmit power at the step S412 or S413 or the other user at step S420, the step 400 and the following steps are performed again.

The overall data rate R of a general multiuser OFDM system can be expressed as Eq 5. Herein, the overall data rate R can be maximized by adaptively allocating the transmit power to each sub carrier of each user.

$$R = {\sum }_{k = 1}^{K} {\sum }_{m = 1}^{M} \frac{{N}_{k , m}}{T} = \frac{B}{M} {\sum }_{k = 1}^{K} {\sum }_{m = 1}^{M} {log}_{2} ( 1 + \frac{{γ}_{k , m}}{Γ} ) \qquad Eq . 5$$

In Eq. 5, K, M denotes the number of users and the number of sub carriers, respectively. N_{k,m} denotes the maximum bits transmitted from the m^{th} sub carrier of the k^{th} user. B denotes the entire bandwidth, and

γ_{k,m}
is an average SNR at the m^{th} sub carrier of the k^{th} user. Γ denotes a target bit error rate (BER). T is a symbol period.

The limited total transmit power ( S̅)

can be expressed as Eq. 6.

$${\sum }_{k = 1}^{K} {\sum }_{m = 1}^{M} {S}_{k , m} = \overline{S} \qquad Eq . 6$$

In Eq. 6,S_{k,m} denotes power allocated to the m^{th} sub carrier of thek^{th} user.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean patent application Nos. 2005-0121134 and 2006-0030283, filed with the Korean Intellectual Property Office on Dec. 9, 2005, and Apr. 3, 2006, respectively, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A method for adaptively allocating transmit power in a multiuser orthogonal frequency division multiplexing (OFDM) system, the method comprising the steps of:
a) obtaining a channel gain for a predetermined bit period for each user at a pre-determined time, and allocating all of available sub carriers to a user farthest separated among a plurality of users having a good channel gain;
b) comparing a channel gain of the user allocated with the subcarrier at the step a) with an initial threshold value;
c) allocating a transmit power uniformly to each of the sub carries allocated at the step a) using an Equal-power allocation algorithm if the channel gain is larger than the initial threshold value at the step b); and
d) allocating a transmit power to each of the sub carriers allocated at the step a) using a water-filling power allocation algorithm if the channel gain is smaller than the initial threshold value at the step b).

2. The method as recited in claim 1, further comprising the step of transmitting information about transmit power allocation of steps c) and d) to a terminal of a corresponding user.

3. The method as recited in claim 1, wherein the initial threshold value is decided using a water-filling power allocation algorithm.

4. The method as recited in claim 1, wherein the step a) includes the steps of:
a-1) selecting two users having good channel gain by obtaining a channel gain of each user for a predetermined bit period at a predetermined time; and
a-2) allocating all of available sub carriers to one farthest from a satellite or a base station between the two selected user at step a-1).

5. The method as recited in claim 1, wherein the step a) includes:
a-3) selecting two users having good channel gain by obtaining a channel gain of each user for a predetermined bit period at a predetermined time;
a-4) determining whether candidates having good channel gain are stored in a buffer or not;
a-5) allocating all of available sub carriers to a user farthest from a satellite and a base station among the two selected user and the candidates if the candidates are stored in the buffer at the step a-4), and deciding users having better channel gain among users excluded for allocating the sub carriers as new candidates; and
a-6) allocating all of available sub carriers to one farthest from a satellite or a base station between two selected users if the candidates are not in the buffer at the step a-4), and deciding user having better channel gain among users excluded for allocating the sub carriers as new candidates.
